(19) United States
(12) Patent Application Publication
(10) Pub. No.: US 2006/0082577 A1
(43) Pub. Date: Apr. 20, 2006

(54) System, method, and computer program product for dynamic shader generation

(75) Inventor: Michael B. Carter, Ames, IA (US)

Correspondence Address: DOCKET CLERK, PO BOX 800889, DALLAS, TX, 75380, US

(73) Assignee: UGS Corp., Plano, TX (US)

(21) Appl. No.: 11/047,375

(22) Filed: Jan. 31, 2005

Related U.S. Application Data
(60) Provisional application No. 60/620,638, filed on Oct. 20, 2004.

(51) Int. Cl. G09G 5/00; G06T 15/50; G06T 15/60

(52) U.S. Cl. 345/426; 345/582

(57) ABSTRACT

A system, method, and computer program product for automatically creating shader source code based on a set of desired graphical output properties.

### CROSS-REFERENCE TO RELATED APPLICATIONS

This application claims the benefit of the filing date of United States Provisional Patent Application 60/620,638 filed Oct. 20, 2004, which is hereby incorporated by reference.

### TECHNICAL FIELD OF THE INVENTION

The present invention is directed, in general, to computer graphics.

### BACKGROUND OF THE INVENTION

Very recent commercial graphics adapters have become highly programmable. They can execute actual code downloaded to them by a controlling application program running on the host computer. Some of these programs downloaded to programmable graphics hardware are called “shaders.” A shader, in general, is a graphics function that applies custom lighting, coloring, and other effects on a pixel-by-pixel basis, on vertices, on polygons, and on other objects, depending on the configuration and programming. A shader allows programmers add complex special effects to objects in a 3-D world. In the current state of the art, it is the job of the user to create these shader programs. Shaders must be created by skilled software professionals, but may be used by skilled artistic professionals.

Artistic professionals often specify the output properties they desire to achieve a certain appearance, but are unable to develop the shader source code they require to produce these properties.

There is, therefore, a need in the art for a system, process and computer program product for automatically creating shader source code based on a set of desired graphical output properties.

### SUMMARY OF THE INVENTION

A preferred embodiment provides a system, method, and computer program product for automatically creating shader source code based on a set of desired graphical output properties. A preferred embodiment supports both of the emerging shader languages Cg and GLSL, and is applicable to other languages (such as HLSL). One important value of the preferred embodiment is that it conveniently produces high-performance shaders that integrate an essentially arbitrary combination of supported graphics effects that cannot be otherwise combined unless specific code is written by a graphics professional. In effect, the disclosed embodiments encapsulate the expert knowledge of a computer graphics professional necessary to craft a shader for a specific purpose from a wide range of possible graphical effects.

The foregoing has outlined rather broadly the features and technical advantages of the present invention so that those skilled in the art may better understand the detailed description of the invention that follows. Additional features and advantages of the invention is described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system in which a preferred embodiment can be implemented;

FIG. 2 depicts JtAttribute, JtTexImage, and JtShader Class Diagrams, in accordance with a preferred embodiment;

FIG. 3 depicts JtLightSet and JtDrawStyle Class Diagrams, in accordance with a preferred embodiment;

FIG. 4 depicts a UML diagram that explains the exact types and enumerations required to implement the interface, in accordance with a preferred embodiment;

FIG. 5 depicts a flowchart of a process of generating vertex shader source code in accordance with a preferred embodiment.

FIG. 6 depicts a flowchart of a process of generating fragment shader source code in accordance with a preferred embodiment.

### DETAILED DESCRIPTION OF THE INVENTION

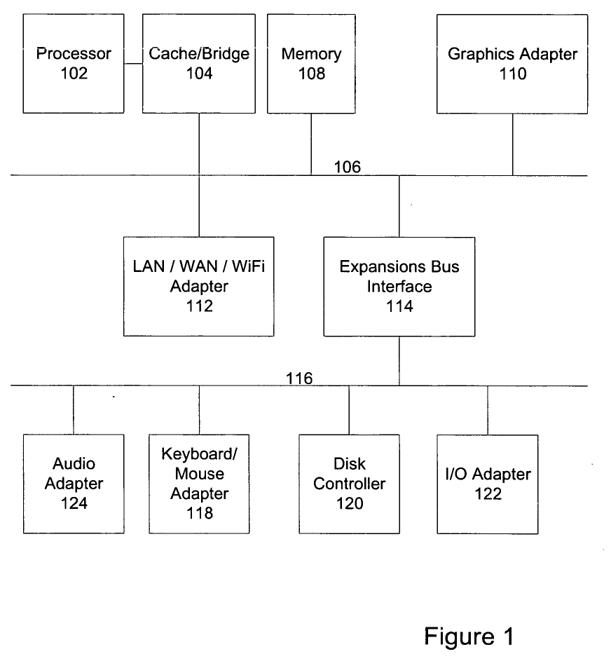

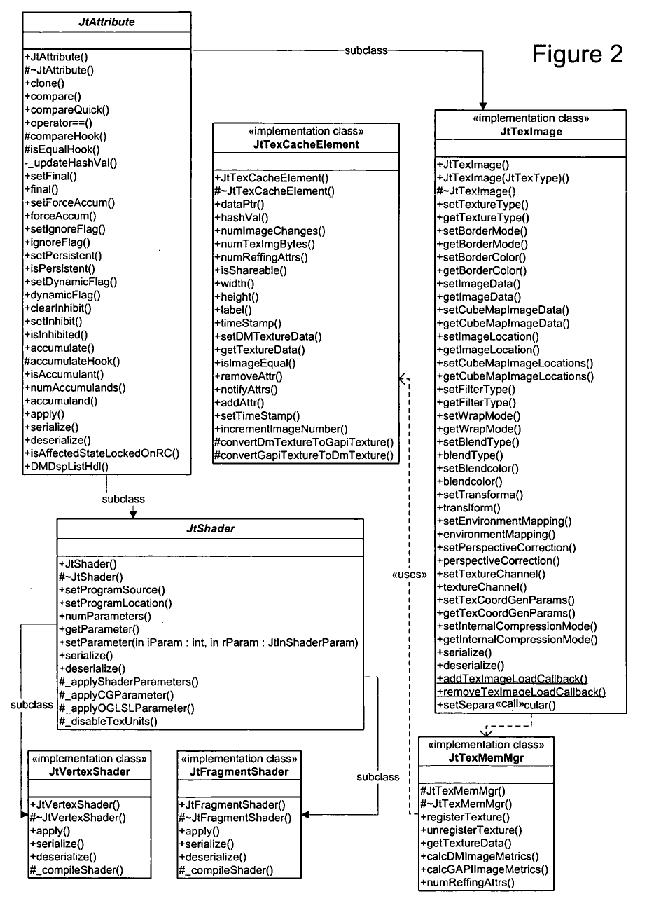

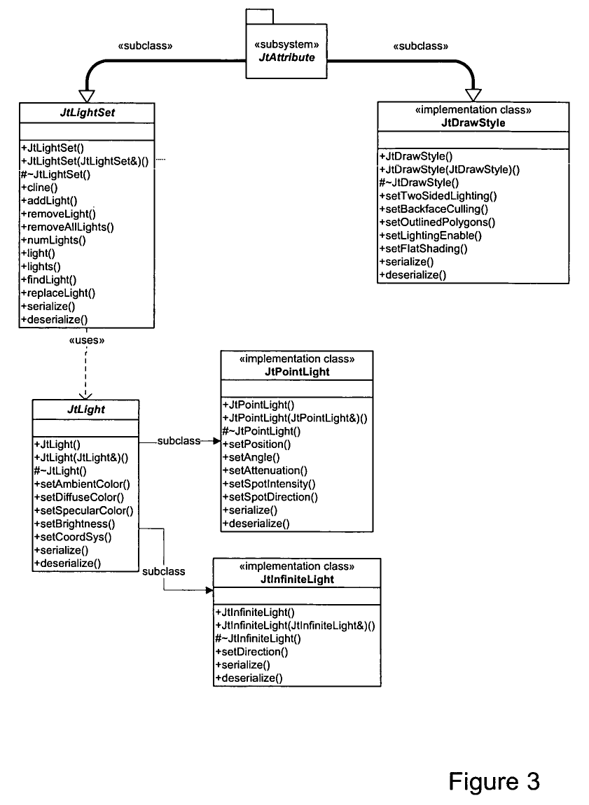

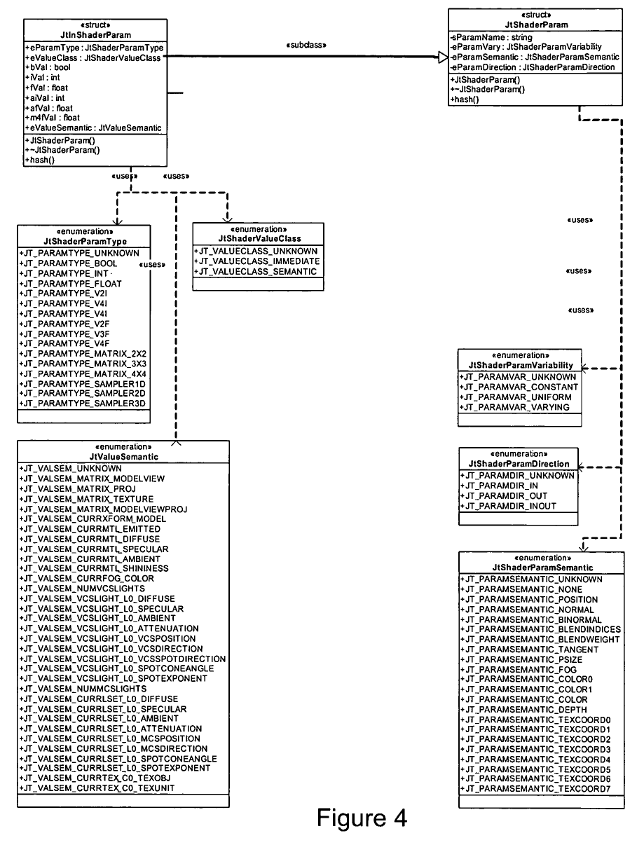

FIGS. 1 through 6, discussed below, and the various embodiments used to describe the principles of the present invention in this patent document are by way of illustration only and should not be construed in any way to limit the scope of the invention. Those skilled in the art invention may be implemented in any suitably arranged device. The numerous innovative teachings of the present application is described with particular reference to the presently preferred embodiment.

FIG. 1 depicts a block diagram of a data processing system in which a preferred embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described.

A preferred embodiment provides a system, method, and computer program product for automatically creating shader source code based on a set of desired graphical output properties. A preferred embodiment, JtShaderEffects, is implemented as a part of a visualization toolkit using in conjunction with modeling systems available from UGS CORP. of Plano, Tex., and supports both of the emerging shader languages Cg and GLSL. An important value of JtShaderEffects is that is conveniently produces high-performance shaders that integrates an essentially arbitrary combination of supported graphics effects that cannot be otherwise combined unless specific code is written by a graphics professional. In effect, JtShaderEffects encapsulates the expert knowledge of a computer graphics professional necessary to craft a shader for a specific purpose from a wide range of possible graphical effects.

While much of the description below is in terms of a specific embodiment relating to JtShaderEffect and the visualization toolkit described above, those of skill in the art will recognize that the teachings herein are not limited to that implementation, but are applicable to many other software applications.

As used herein, the term JtAttribute refers to a modifier, placed in a scene graph, which is intended to express some aspect of the manner in which the geometric objects lying in the scene graph are to be rendered. Each JtAttribute encodes a small piece of how objects are to be rendered by the system. Examples of JtAttributes are material color, texture maps, and light sources. These JtAttributes are “washed” or “accumulated” down the graph to arrive at a final “JtState” that represents the full description of how an object is to be rendered.

JtShaderEffects has the challenging task of taking a description of the specific visual effects desired by the application, mixing this description together with the JtAttributes that are current at some point in the scene graph, and translating that description into on-the-fly generated JtShaders such that when applied, produce the desired visual effect.

JtShaderEffects is itself a JtAttribute, and is washed down the scene graph along with all other attributes. The attribute washing mechanism automatically detects the attribute changes to the logical scene graph (LSG), and re-washes the attributes in the affected portion of the LSG as needed. The result of this operation is a fully-specified, comprehensive, and up-to-date JtState for each renderable entity in the LSG. These accumulated JtShaderEffects attributes can then generate shader source code using the full knowledge of the modeling system state. The controlling application's responsibilities are considerably simplified, and the modeling system then has control over when shader source code is generated, and in doing so only as necessary.

Existing JtAttributes are to be regarded as low-level controls whose function closely matches the underlying graphics interface (OpenGL, in this case), and controls for “higher-order” visual effects are grouped into the JtShaderEffects' API. Let us illustrate this with an example. Consider the three concepts of texture mapping, environment mapping, and bump (or normal) mapping. Texture mapping is a generic function that is handled by the JtTexImage attribute. A texture map does not imply any specific high-level usage or intent as does an environment map or bump map. With these two latter cases, their functions are implemented using the generic texture mapping capabilities, but the bump map and environment maps themselves carry the additional implicit meaning of precisely how their texture images are to be used and for what purpose. Furthermore, the OpenGL graphics API does not embody concepts of environment mapping or bump mapping directly.

Thus, texture mapping is a function to be managed by a modeling system JtAttribute, and environment mapping and bump mapping are functions to be handled by the JtShaderEffects. Similar reasoning is applied to the additional effects of Phong shading, shadow generation, and paint effects.

The JtShaderEffects accepts the following visual feature requests, which are all blended together into an integrated implementation: Model coordinate light sources (implicitly from the currently accumulated JtState); View coordinate light sources (implicitly from the currently accumulated JtState); World coordinate light sources (implicitly from the currently accumulated JtState); Multiple texture maps (implicitly from the currently accumulated JtState); Environment map (spherical or cube; this feature designates one of the active texture maps to be applied as an environment map); Bump map (this feature designates one of the active texture maps to be applied as a bump map); Phong or Gouraud shading; and Shadows.

When a JtShaderEffects attribute is accumulated into a JtState, it uses the complete description of the graphical state present in JtState to know what kinds of graphical features to support. For example, the JtState encodes: The number and types of light sources present; All texture maps to be applied, and their associated texture environment specifying how they are to be used; Any automatic generation of texture coordinates; A texture map may be designated as a bump map; A texture map may be designated as an environment map, and its reflectivity may be present; and the material colors (ambient, specular, diffuse, emitted) and their associated parameters (shininess, alpha).

No single shader can presently deal with all possible combinations of these parameters in an efficient manner. Thus, JtShaderEffects examines this list of graphical features, and generates one or more shader programs specifically crafted to run as optimally as possible on the underlying graphics hardware.

Various embodiments add new functionality to the modeling system graphics middleware toolkit and JT file format to support important new capabilities for texturing, materials, images, shadows, and most notably, shaders.

The following definitions and terms are used herein, but those of skill in the art will recognize when a conventional meaning, rather than the specific definition given below, applies:
Shader—A user-definable program, expressed directly in a target assembly language, or in high-level form to be compiled. A shader program replaces a portion of the otherwise fixed-functionality graphics pipeline with some user-defined program. At present, hardware manufacturers have made it possible to run a shader for each vertex that is processed and/or each pixel that is rendered.
Vertex Shader—A small user-defined program that is run for each vertex that is sent to the GPU and processed. A vertex shader can alter vertex positions and normals, generate texture coordinates, perform Gouraud vertex lighting, etc.
Pixel Shader—(More accurately called fragment shader.) A fragment is a proto-pixel generated by triangle scan-conversion, but not yet laid down into the frame buffer) A small user-defined program is run for each fragment generated by the hardware's scan-conversion logic. A fragment shader can support sophisticated effects like Phong shading, shadow mapping, bump mapping, reflection mapping, etc.
Cg—A high-level, C-like shading language designed and promoted by nVIDIA.
OGLSL—A high-level, C-like shading language becoming available in OpenGL 2.0 implementations. Designed and promoted by 3Dlabs as a more vendor-neutral and platform-neutral alternative to Cg.
HLSL—A high-level, C-like shading language for the Direct3D graphics API, designed cooperatively between Microsoft and nVIDIA. Supported by nVIDIA and ATI. HLSL is, at present, essentially identical to Cg.
Texture mapping—A technique of mapping a texture image (q.v.) onto geometric entities. In its simplest form, texture mapping resembles applying wallpaper to a surface. A texture map is a composite entity which is broken into two pieces: a texture image and the texture environment.
Texture image—An image, usually a two-dimensional color image, used for texture mapping. As the name implies, a texture image is only a rectangular array of texels (c.f. pixels), and does not contain or imply any information about how the image is to be mapped onto geometry.
Texture environment—This is a composite set of individual attributes that precisely describe how a texture image (q.v.) is to be mapped onto a piece of geometry. Typical elements of the texture environment include: wrap/clamp modes, blending type, automatic texture coordinate generation functions, etc.
Bump mapping—A texture mapping technique by which the per-pixel normal vector is adjusted based on a stored normal map in order to cause small scale shading effects that are common to low-relief rough surfaces.
NVIDIA—A graphics hardware vendor, based in Santa Clara, Calif. Maker of the Quadro (professional line) and GEForce (consumer line) GPUs. Currently competing commercially with ATI (q.v.) for marketplace and technical dominance in the commodity graphics hardware business. Inventor of the Cg high-level shading language for OpenGL. Co-inventor of the HLSL shading language for Direct3D.
ATI—A graphics hardware vendor, based in Markham, Ontario, Canada. Currently competing commercially with nVIDIA (q.v.) for marketplace and technical dominance in the commodity graphics hardware business. Mostly services the gaming industry, but offers several competent OpenGL products.
3Dlabs—A graphics hardware vendor, a wholly owned subsidiary of Creative Technologies, Inc. Maker of the Wildcat and Realizm lines of professional graphics adapters. Author of the OpenGL Shading Language (q.v.). Prominent in high-end and immersive applications that are too small or specialized to attract much attention from nVIDIA and ATI.
GPU—Graphics processing unit. This term has become predominant when referring to graphics hardware because of the more programmable nature of modern graphics hardware. Compare with the term CPU.

The following documents are hereby incorporated by reference:
“The Cg Tutorial,” Randima Fernando and Mark J. Kilgard, nVIDIA Corporation, Addison Wesley Publishing Company, April 2003; The OpenGL 1.5 Specification. http://www.opengl.org/documentation/spec.html;
OpenGL Shading Language Specification, http://www.opengl.org/documentation/oglsl.html; and the Cg Toolkit Users Manual, http://developer.nvidia.com/object/cg_users_manual.html;

JtShaderEffects: JtShaderEffects is this feature's centerpiece. JtShaderEffects is derived from JtAttribute, and is propagated down the LSG, just as other JtAttributes are.

JtShaderEffects has the challenging task of taking a description of the specific visual effects desired by the application, mixing this description together with the JtAttributes that are current at some point in the scene graph, and translating that description into on-the-fly generated JtShaders such that when applied, produce the desired visual effect.

This scheme has a crucial advantage over previous schemes where the JtShaderEffects was a “factory-like” object. Consider the following scenario: assume a scene graph, with a JtShaderEffects applied at the root node, and a default set of lights also at the root node. Now, consider what happens when an additional light or an additional JtTexImage is added somewhere in the body of the scene graph. In this subgraph, the actual generated shader source must be different in order to account for the new light or texture.

If JtShaderEffects is implemented as a factory-like object, then the controlling application must realize that there are two distinct situations in the LSG that require different shader source code, and deal with the JtShaderEffects twice, taking care to anoint the LSG appropriately with its results. Thus, the controlling application carries a heavy burden of tracking attribute changes to the LSG, and regenerating arbitrary amounts of shader code upon any attribute changes. In short, this method does not take any advantage of the modeling system's strong and lazy attribute accumulation mechanism.

If, however, the JtShaderEffects is a JtAttribute, it is washed down the LSG along with all other attributes. In the situation described above, the existing attribute washing mechanism automatically detects the attributes changes to the LSG, and re-wash the attributes in the affected portion of the LSG as needed. The natural result of this operation is two distinct attribute states at the leaf level: the original one washed down from the root node, and the modified one caused by the addition of the light or texture map. These accumulated JtShaderEffects attributes can then generate shader source code using the full knowledge of the modeling system state. The controlling application's responsibilities are considerably simplified, and the modeling system then has control over when shader source code is generated, and in do so only as necessary.

The detailed operation of how ShaderEffect functions best begins with a description of its needed inputs, and intended output.

Let us first describe the inputs to the present embodiment of ShaderEffects. One skilled in the art will see that additional parameters can be added to ShaderEffects to describe additional visual effects. JtShaderEffects is not limited to the specific inputs described here—they are merely the ones provided to the first implementation.

From the accumulated JtState

All defined light source data. Specifically, for each light source:

Light source type (infinite light, point light, spotlight, etc.),

Light source coordinate system, such as model-, world-, or viewpoint coordinates. These data control which geometric coordinate system the light source acts within.

Light source position (if point- or spotlight),

Light source direction (if infinite light)

Light source color information. This includes all modeled parameters such as diffuse color, specular color, and ambient color.

Spotlight parameters (if light is a spotlight), including spot direction, cone angle, and falloff parameters that control the distribution of light intensity over the cone angle.

Lighting information, such as:

Whether lighting is enabled

Whether two-sided lighting is enabled

Whether backface culling is enabled

All defined active textures. For each defined and active texture, the following data is used:

The texture's channel number. Multiple textures may be applied simultaneously, with textures from higher-numbered channels laying on top of lower-channeled textures.

A method of accessing the texture itself within a shader, such as the texture's OpenGL texture object name or its associated OpenGL texture unit number.

The texture's texgen environment. These settings are used to automatically generate texture coordinates during vertex processing according to some preset scheme.

The texture transform matrix.

From the ShaderEffects itself

Which texture map, if any, is designated as an environment map. Also specified along with these parameters is a reflectivity parameter which controls how intensely a mapped surface will reflect the environment map.

Which texture map, if any, is designated as a bump map. Also specified along with this parameter are two others. The first is a flag that encodes whether the texture map is to be interpreted as a tangent space bump map, or as a model space bump map. A tangent space map encodes a normal vector perturbation relative to the surface's inherent normal. A model space bump map is interpreted verbatim as the desired normal vector map, and hence, must be crafted by the user specifically for a give piece of geometry. A second bumpiness parameter is provided as a convenient way of adjusting the visual magnitude of the perturbations in a tangent space normal map.

Whether Phong (per pixel) lighting is enabled.

Which shading language is to be targeted; either GLSL or Cg.

From the shared graphics environment

Global lighting model information, including but not limited to global ambient light color.

Parameters related to the viewing mode, including but not limited to 4-by-4 model-, view-, and projection matrices.

Also part of the output from JtShaderEffects is a list of shader parameters that must be connected to the necessary graphical and geometric quantities present in the hosting graphics system.

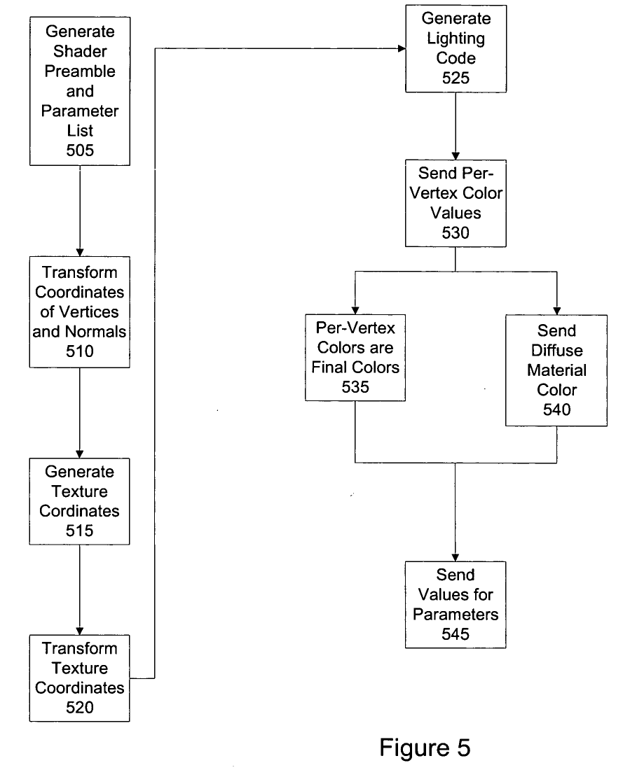

FIG. 5 depicts a flowchart of a process for generating a vertex shader, in accordance with a preferred embodiment.

In order to generate a vertex shader, JtShaderEffects performs the following broad steps:

Generate the shader preamble and parameter list using the information above (step 505). Shader parameters are necessary for:

Input: The incoming vertex position, normal vector, and vertex color.

Input: Texture coordinates for each available and active texture channel

Input: If tangent space bump mapping is selected, then per-vertex model coordinate tangent vectors are required

Input: Model-, View-, and Projection matrices.

Input: Texture matrices for each active texture channel.

Input: If Gouraud shading is selected, all parameters necessary to fully describe all active light sources

Input: If Gouraud shading is selected, all parameters necessary to describe the current material properties (color, shininess, etc.)

Input: Any texture coordinate generation parameters for texture channels requiring it.

Output: The outgoing transformed vertex position, untransformed vertex position, transformed normal vector.

Output: If tangent space bump mapping is selected, then view-coordinate tangent vectors must be passed out of the vertex shader.

Output: Transformed texture coordinates

Output: The color, either computed though lighting calculations, or otherwise, associated with the current vertex.

Generate the program body source code

Incoming vertices and normals are transformed from their native model coordinates into the view coordinate system (step 510).

Texture coordinates are generated for each active texture channel if the corresponding texgen environment calls for such (step 515).

All channels' texture coordinates are transformed by their respective texture matrices (step 520).

If Gouraud lighting is selected, then lighting code is generated for each light source (step 525). The resulting lighting contributions from each light source are summed up, and presented to the appropriate output shader parameter to be passed along the graphics pipeline.

If Gouraud lighting is selected, then the results of the per-vertex lighting code from above is passed along to the fragment shader for further processing (step 532).

If Phong lighting is selected, then per-vertex color values are passed along to the fragment shader for further processing (step 530).

If no lighting at all is performed, then per-vertex colors are passed along as the final color (step 535). If per vertex colors are not present, then the current diffuse material color is passed along instead (step 640).

Send vertex shading code to the hosting graphics system, in a manner appropriate to the host system, and as known to those of skill in the art, including the values to be bound to each of the input shader parameters (step 645).

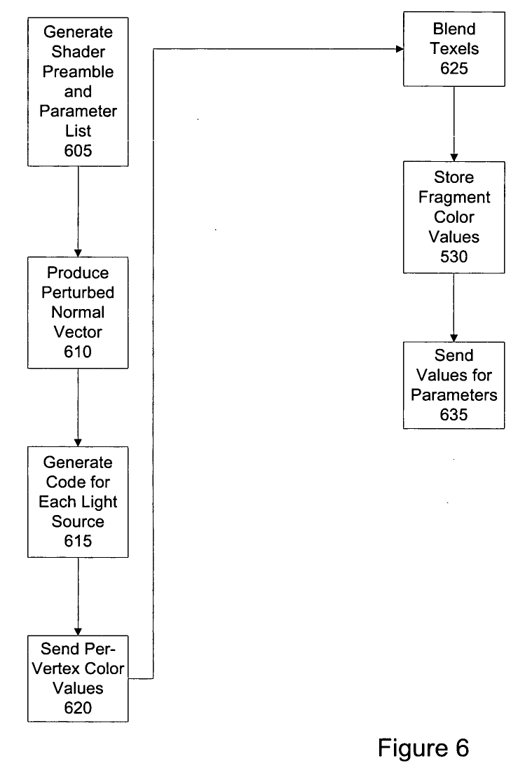

FIG. 6 depicts a flowchart of a process for generating a fragment shader, in accordance with a preferred embodiment.

In order to generate a fragment shader, JtShaderEffects performs the following broad steps:

Generate the shader preamble and parameter list using the information above (step 605). Shader parameters are necessary for the following. Note that many of these inputs are directly bound to outputs from the corresponding vertex shader.

Input: The incoming vertex position, normal vector, and vertex color.

Input: Texture coordinates for each available and active texture channel

Input: If tangent space bump mapping is selected, then per-vertex view coordinate tangent vectors are required from the vertex shader

Input: Model-, View-, and Projection matrices.

Input: If Phong shading is selected, all parameters necessary to fully describe all active light sources

Input: If Phong shading is selected, all parameters necessary to describe the current material properties (color, shininess, etc.)

Input: Handles (or samplers) to each active texture image.

Input: If environment mapping is selected, the environment map reflectivity.

Input: If tangent-space bump mapping is selected, the bumpiness to be applied to the bump map.

Output: The color, either computed though lighting calculations, or otherwise, associated with the current pixel.

Generate the program body source code as follows:

If bump mapping is selected, generate code to access the specified bump map and use it to perturb the existing normal vector, or produce a new one outright (step 610). This perturbed normal vector feeds directly into any lighting computations performed below.

If Phong lighting is selected, then lighting code is generated for each light source (step 615). The resulting lighting contributions from each light source are summed up, and placed into a running temporary fragment color variable which may be modified by later texturing code.

If Gouraud lighting is selected, then per-vertex color values passed in from the vertex shader are copied out verbatim (step 620). If no lighting at all is performed, then per-vertex colors are copied out verbatim.

If texturing is present, generate code that accesses the requested Texel, and blends it with the above-computed running temporary fragment color according to the texture blend mode (step 625). This step includes generating shader source code for environment mapped textures.

The final running temporary fragment color value is stored as the appropriate output shader parameter for further processing by the graphics pipeline back-end (step 630).

Send vertex shading code to the hosting graphics system, in a manner appropriate to the host system, and as known to those of skill in the art, including the values to be bound to each of the input shader parameters (step 635).

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 100 may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method for generating code for a vertex shader, comprising:
generating a shader preamble and parameter list for the vertex shader;
transforming coordinates of vertices and normals;
optionally generating texture coordinates and transforming texture coordinates;
sending vertex shader source code, corresponding to the transformed texture coordinates and the transformed coordinates of vertices and normals, to a graphics processing unit, the vertex shader code including values for at least some shader parameters.

2. The method of claim 1, further comprising generating lighting code for each lighting source if Gouraud shading is selected.

3. The method of claim 1, further comprising generating code to pass per-vertex color values to a fragment shader if Phong lighting is selected.

4. The method of claim 1, further comprising generating code to pass per-vertex color values to a fragment shader as a final color if no lighting is performed.

5. A method for generating code for a fragment shader, comprising:
generating a shader preamble and parameter list for the fragment shader;
storing fragment color values;
sending fragment shading code including parameter values.

6. The method of claim 5, further comprising generating code to compute a new normal vector using a bump map if bump mapping is selected.

7. The method of claim 5, further comprising generating lighting code for each lighting source if Phong shading is selected.

8. The method of claim 5, further comprising generating code to pass interpolated per-vertex color values as the final fragment color if Gouraud lighting is selected.

9. The method of claim 5, further comprising generating code to access all textures and blend the resulting texels together with one another and with the lit fragment color if texturing is present.

10. The method of claim 5, further comprising generating code to access an environment map texture and blend the resulting texel against the lit fragment color according to a environment map reflectivity parameter.

11. The method of claim 1, further comprising generating additional code to access an environment map texture and blend the resulting texel against the lit fragment color and other non-environment texels according to a environment map reflectivity parameter.

12. A method for regenerating code for a shader, comprising:
receiving first shader code, the shader code including a plurality shader parameter values and first object attributes;
receiving changed object attributes;
generating updated shader code according to the shader code and the changed object attributes, where the changed object attributes are used in place of corresponding first object attributes;
sending the updated shader source code to a graphics processing unit.
